(19) United States
(12) Patent Application Publication
(10) Pub. No.: US 2023/0251030 A1
(43) Pub. Date: Aug. 10, 2023

(54) FACILITY AND METHOD FOR HYDROGEN REFRIGERATION

(71) Applicant: L'Air Liquide, Societe Anonyme pour l'Etude et l'Exploitation des Procedes Georges Claude, Paris (FR)

(72) Inventors: Bertille GUENEGO, Champigny-Sur-Marne (FR); Patrick LE BOT, Champigny-Sur-Marne (FR); Axelle GAERTNER, Champigny-Sur-Marne (FR)

(73) Assignee: L'Air Liquide, Societe Anonyme pour l'Etude et l'Exploitation des Procedes Georges Claude, Paris (FR)

(21) Appl. No.: 18/014,284

(22) PCT Filed: May 27, 2021
(86) PCT No.: PCT/EP2021/064230

§ 371 Date: Jan. 3, 2023

(30) Foreign Application Priority Data
Jul. 3, 2020 (FR) FR 2007081

(51) Int. Cl. F25J 1/00; F25J 1/02

(52) U.S. Cl. CPC F25J 1/001; F25J 1/004; F25J 1/0037; F25J 1/0045; F25J 1/0208; F25J 1/0257; F25J 2245/90; F25J 2270/06; F25J 2290/60; F25J 2290/62

(57) ABSTRACT

Certain embodiments of the invention relate to a facility for refrigerating hydrogen to cryogenic temperatures, and in particular for liquefying hydrogen, comprising a circuit for hydrogen to be refrigerated comprising an upstream end to be connected to a hydrogen source, and a downstream end connected to a refrigerated hydrogen collection member, the refrigeration facility comprising a set of one or more heat exchangers in thermal exchange with the circuit of hydrogen to be refrigerated, the facility comprising a device for refrigerating by heat exchange with the set of one or more heat exchangers, the refrigerating device comprising a refrigerator with a refrigeration cycle of a cycle gas such as hydrogen, at least one portion of the hydrogen circuit, of the set of one or more exchangers and of the refrigerating device being housed in a vacuum-insulated cold box, the facility comprising in the cold box, at least one ejector the suction inlet of which is connected to the gas phase of a fluid capacity and the motor fluid intake inlet of which is connected to at least one among: the pressurized cycle gas of the refrigerator, the hydrogen of the hydrogen circuit refrigerated in the set of one or more heat exchangers.

### CROSS REFERENCE TO RELATED APPLICATIONS

This application is a § 371 of International PCT Application PCT/EP2021/064230, filed May 27, 2021, which claims the benefit of FR2007081, filed Jul. 3, 2020, both of which are herein incorporated by reference in their entireties.

### FIELD OF THE INVENTION

The invention relates to a facility and a method for the refrigeration of hydrogen.

### BACKGROUND OF THE INVENTION

The expansion of the market for hydrogen as a fuel for mobility purposes will give rise to the generation of large hydrogen liquefaction capacities for the logistics of using the product in liquid form. Liquid hydrogen at very low temperature generates, in the phases of storage and of filling the trucks, boil-off gas that needs to be recirculated so as to recover not only the hydrogen molecules but also the cold energy contained in these cold gases. In order to do that, one known means is to send a supercooled liquid into the capacity that receives the liquid produced by the liquefier (the store or semitrailer).

Another solution is to use an ejector to return the boil-off gas to a fixed store.

In order to increase the pressure of the boil-off gas coming from the fixed store and allow this gas to be injected into a liquefier, use may be made of an ejector.

Ejectors enable a low-pressure stream (the drawn-in intake fluid) to be pressurized by the expansion of a high-pressure stream (the driving fluid).

The stream of hydrogen that is to be cooled can be used as a driving fluid. However, this use of the pressure of the hydrogen that is to be cooled reduces the possibilities of cooling said stream (by expansion) in order to produce an even colder fluid.

One aim of the present invention is to remedy all or some of the drawbacks of the prior art that are set out above.

### SUMMARY OF THE INVENTION

In certain embodiments, the invention more particularly relates to a facility for refrigerating hydrogen to a cryogenic temperature, and notably for liquefying hydrogen, comprising a circuit for hydrogen that is to be cooled, comprising an upstream end intended to be connected to a hydrogen source and a downstream end connected to a member for collecting the cooled and/or liquefied hydrogen, the cooling facility comprising a set of heat exchanger(s) in a heat exchange relationship with the circuit for hydrogen that is to be cooled, the facility comprising a cooling device in a heat exchange relationship with the set of heat exchanger(s), said cooling device comprising a refrigerator performing a refrigeration cycle on a cycle gas in a working circuit, the cycle gas being hydrogen, the working circuit of the refrigerator comprising a member for compressing the cycle gas, a member for cooling the cycle gas, a member for expanding the cycle gas comprising at least one turbine, and a member for warming the cycle gas.

In an effort to overcome the deficiencies of the prior art discussed supra, the facility according to the invention, in other respects in accordance with the generic definition thereof given in the above preamble, can include at least an ejector of which the driving-fluid inlet is connected, via a set of pipe(s) and valve(s), to the working circuit of the refrigerator downstream of the expansion member, the suction intake of the ejector being connected to a set of pipe(s) equipped with valve(s) having one end intended to be connected to the gas overhead of at least one mobile tank for transporting liquefied hydrogen, notably a liquefied hydrogen transport tank intended to be filled with liquid hydrogen by the downstream end of the hydrogen circuit, the outlet of the ejector being connected, via a set of pipe(s) and valve(s), to the working circuit of the refrigerator.

Furthermore, embodiments of the invention may have one or more of the following features:
the facility comprises several ejectors,
the facility comprises at least one liquefied hydrogen tank transport tank comprising a fluid inlet configured to be connected removably to the downstream end of the hydrogen circuit with a view to being filled with cooled hydrogen, the at least one tank comprising a boil-off gas outlet configured to be connected removably to the suction intake of the ejector (8) via the set of pipe(s) equipped with valve(s),
the cooling device comprises a pre-cooling member in a heat exchange relationship with part of the set of heat exchanger(s),
the outlet stream leaving the ejector is at a pressure of between 1.25 and 2 bara and preferably between 1.3 and 1.45 bara,
the flowrate of driving fluid is controlled as a function of the outlet pressure of the ejector, said flowrate being regulated to maintain a constant pressure set point at the outlet of the ejector,
the working circuit of the refrigerator comprises several heat exchangers in series between a hot end of the working circuit in which end the working fluid is at a relatively high pressure, and a relatively cold end of the working circuit in which end the fluid is at a relatively low pressure, the outlet stream from the ejector being injected into the working circuit at the cold end,
the method comprises, simultaneously, drawing boil-off gas from a plurality of mobile liquefied hydrogen transport tanks into the suction intake of a plurality of using, as driving fluid for the ejectors, pressurized working gas from the working circuit, the outlet streams from the ejectors being injected into the working circuit.
The invention also relates to a method for refrigerating hydrogen to a cryogenic temperature, notably for liquefying hydrogen, using a facility in accordance with any one of the features above or below, comprising a step of drawing boil-off gas from a mobile liquefied hydrogen transport tank into the suction intake of the ejector using, as driving fluid for the ejector, pressurized working gas from the working circuit, the outlet stream from the ejector being injected into the working circuit.

According to other possible distinguishing features:
the boil-off gas sucked up is at a pressure of between 1.01325 and 1.5 bara, and preferably of between 1.15 and 1.3 bara and at a temperature the saturation temperature of the hydrogen and 60 K,
the pressure of the driving fluid is between 5 and 10 bara, and preferably between 6 and 7 bara, the temperature of the driving fluid being between 28 and 35 K and preferably between 29.3 and 30 K,
the outlet stream leaving the ejector is at a pressure greater than or equal to the pressure of the cycle gas at the coldest point in the working circuit.

The invention may also relate to any cooling device or method comprising any combination of the features above or below within the scope of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention’s scope as it can admit to other equally effective embodiments.

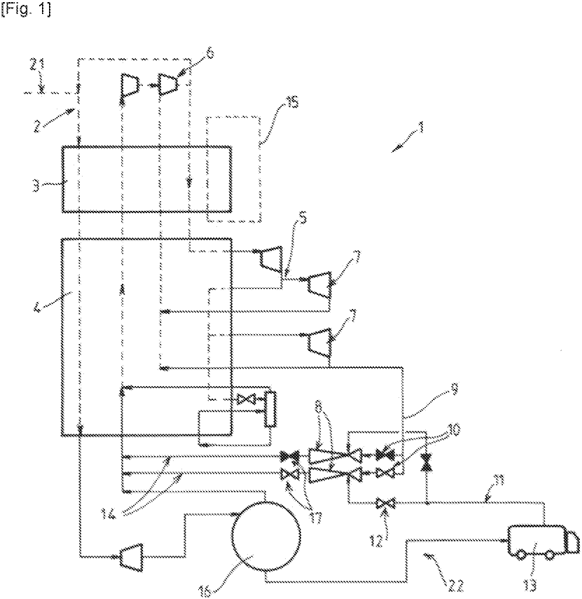

Other distinctive features and advantages will become apparent on reading the description below, given with reference to:

[FIG. 1] which depicts a diagrammatic and partial view illustrating an example of structure and operation of a hydrogen refrigeration/liquefaction facility according to the invention.

### DETAILED DESCRIPTION OF THE INVENTION

The facility 1 for refrigerating hydrogen to a cryogenic temperature, and notably for the liquefaction of hydrogen, comprises a circuit 2 for hydrogen that is to be cooled, comprising an upstream end 21 intended to be connected to a hydrogen source and a downstream end 22 connected to a member for collecting the cooled hydrogen (liquid buffer store 17 and/or piping for filling tanks 13).

The cooling facility 1 comprises a set of heat exchanger(s) 3, 4 in a heat exchange relationship with the circuit 2 for hydrogen that is to be cooled. The facility 1 comprises a cooling device in a heat-exchange relationship with the set of heat exchanger(s) 3, 4, said cooling device comprising a refrigerator 5 performing a refrigeration cycle on a cycle gas consisting of hydrogen or containing hydrogen (and/or any other appropriate gas, for example helium).

At least part of the hydrogen circuit 2, of the set of exchanger(s) 3, 4 and of the cooling device (the cold part thereof) are preferably housed inside a vacuum insulated cold box. Specifically, given the temperature levels employed (for example of the order of 20 K), the hydrogen liquefaction and (super)cooling heat exchangers 3, 4 are installed inside a space that is enclosed and under vacuum (which is to say at a very low pressure).

The working circuit of the refrigerator 5 comprises, disposed in series, a cycle-gas compression member 6, a cycle-gas cooling member 3, 4, a cycle-gas expansion member 7 comprising at least one turbine, and a cycle-gas warming member 4, 3.

The compression member 6 comprises for example 2 compressors in series, with their inlets for example at different pressure levels.

The set of exchanger(s) 3, 4 comprises for example two heat exchangers in series, for example counterflow heat exchangers which cool and warm the working fluid simultaneously according to the direction of passage in the working circuit.

As illustrated, the cooling device of the facility 1 may comprise a pre-cooling member 15 in a heat exchange relationship with part of the set of heat exchanger(s) 3, 4, notably the first exchanger 3 downstream of the compression member 6. This precooling member 15 may for example use another refrigerator, for example using another working fluid, for example nitrogen. For example, this precooling member 15 allows the fluid to be pre-cooled to a temperature of between 70 and 100 K.

After this precooling, the hydrogen refrigerator 5 performs additional cooling of the circuit 2 down to the target temperature (the temperature at which the hydrogen liquefies).

The working circuit of the refrigerator 5 imposes on the working fluid a thermodynamic cycle having a part at a relatively low pressure (ascending from the bottom upward in the schematic depiction) and a part at a relatively higher high-pressure (descending from the top downward in the schematic depiction). The working fluid (hydrogen) in particular undergoes an expansion in at least one turbine of the expansion member in order to produce cold.

The facility 1 comprises at least one ejector 8 of which the driving-fluid intake is connected, via a set of pipe(s) 9 and valve(s) 10 (notably isolation valve(s)), to the working circuit of the refrigerator 5 downstream of the expansion member 7, notably downstream of an expansion turbine.

The suction inlet of the ejector 8 is connected to a set of pipe(s) 11 equipped with valve(s) 12 (notably isolation valve(s)), and having an end that can be connected to the gas overhead of at least one mobile liquefied hydrogen transport tank 13.

In particular, the suction inlet may be fluidically connected to the gas overhead of a liquefied hydrogen transport tank 13 intended to be filled with liquid hydrogen by the downstream end 22 of the cooled-hydrogen circuit 2 of the facility 1.

The outlet of the ejector 8 is for its part connected, via a set of pipe(s) 14 and valve(s) 17, to the working circuit of the refrigerator so as to reinject thereinto.

The stream of gas (boil-off gas) drawn up from the tanks 13 that have just been connected to the circuit 2 supplying cooled (notably liquefied) hydrogen may for example be between 1.01325 and 1.5 bara, and preferably of between 1.15 and 1.3 bara (pressure at the outlet of the tank 13 for example). The temperature of this gas may be comprised between the saturation temperature and 60 K.

The stream of driving gas for the ejector 8 that is used for pressurizing is part of the working gas of the hydrogen-based cooling cycle. This driving gas is gas that has preferably passed through several exchangers and which has been expanded by at least one turbine 7 of the expansion member.

Ideally, this gas used as a driving stream to drive the ejector 8 is taken from the outlet of the last turbine (if there are a plurality of turbines in series in the working circuit) and/or the coldest outlet of the circuit (if there are a plurality of turbines 7 in parallel in the circuit).

The pressure of this driving gas is for example between 5 and 10 bara and preferably between 6 and 7 bara. The temperature of this driving gas may be for example between 28 and 35 K and, preferably, between 29.3 and 30 K.

The gas stream leaving the ejector 8 is dependent on the performance of the ejector and on the characteristics of the suction-intake stream and of the driving-gas stream.

A refrigerator using a refrigeration cycle conventionally subjects a cycle gas (working gas) to a thermodynamic cycle in which the temperature and pressure conditions are determined according to the positions in the cycle. In particular, the cycle fluid, at an end known as the coldest end of the cycle, reaches a temperature that in relative terms is the coldest temperature in the cycle, at determined corresponding pressure conditions.

As a preference, the pressure of the gas stream leaving the ejector is at least equal to the pressure of the low-pressure stream of working fluid of the cooling cycle at its coldest point (in the working circuit), so as to be recirculated (injected). This pressure may for example be between 1.25 and 2 bara and preferably between 1.3 and 1.45 bara.

What that means to say is that on leaving the ejector, the stream has a pressure higher than this pressure of the cycle gas at the coldest end of the cycle.

In order to achieve that, the flowrate of the driving stream coming from the outlet of the turbine 7 and that passes through the ejector 8 can be controlled as a function of the pressure conditions of the stream leaving the ejector 8. The flowrate may in particular be regulated in such a way that the pressure set point is constant and slightly higher than the pressure of the low-pressure stream of the working fluid in the cooling cycle.

Of course, the flowrate of the ejector or ejectors 8 is dependent on the number of tanks 13 (trailers) used and filled at the downstream end 22 of the cooled hydrogen circuit of the facility.

It is preferred that the outlet stream from the ejector 8 enters the cold box of the liquefier of the facility and mixes with the low-pressure stream of working fluid of the cooling cycle of the liquefier. As illustrated, this outlet stream from the ejector 8 is injected preferably into the working circuit before the working fluid returns to the compression member 6 (before the passage through the exchangers 4, 3 that perform warming up to the inlet of the low-pressure compressor 6).

The mixing (injection) is therefore preferably performed at the cold end of the last exchanger 4 of the working circuit (above the thermosiphon exchanger if there is one, and in the last series-exchanger 4 if there is no thermosiphon). What this means to say is that the boil-off gas recovered in the tank 13 is mixed at this point in the working circuit with any boil-off gas that may have come from a fixed store 16 (where applicable) and with the gas coming from the outlet of a thermosiphon (where applicable).

The boil-off gas supplied by mobile tanks 13 that are to be filled with liquid is intermittent because it is linked to the presence of filled trailers 13. Therefore, as illustrated, the ejector or ejectors 8 preferably need to be able to be isolated from the liquefier 8 and from the piping used for filling the trailers 13, using a set of isolation valves 10, 12, 17. These valves need to be closed when no boil-off gas is to be recovered.

A plurality of tanks 13 can be filled simultaneously in the facility. This implies that the flowrate of boil-off gas that is to be recovered may be highly variable. However, ejectors 8 do not work optimally across broad ranges of flowrate (the acceptable range of variation for the inlet flowrate of an ejector is around 75% to 100%).

Thus, as illustrated, a plurality (notably two or more) of the ejectors 8 in the facility 1 may therefore be arranged and connected in parallel with respective valves. The recommended number of ejectors 8 is preferably the maximum number of tanks 13 capable of simultaneously generating low-pressure boil-off gas (which is something that occurs when this tank or these tanks 13 receive liquid from the store 16 via the line 22). Specifically, a truck may be received at the facility 1 without generating these low-pressure gases: it may be in the process of being coupled, or in a depressurization phase (generating high-pressure boil-off gases that do not require the use of the ejector). For example, two or four ejectors may be provided, or any other number depending on the facility.

For each ejector 8, the corresponding valve sets need to be able to be placed in an open or closed position independently, according to the number of tanks 13 that are generating boil-off gas at any given moment. In the schematic illustration a single tank 13 is connected and the facility comprises two ejectors 8 of which one is isolated (valves closed shown in black) and just one is in use (valves open shown in white).

This solution allows a large quantity of boil-off gas stream to be recirculated, recouping the benefit of its cold temperature. Compared with the current solutions which use the hydrogen stream of the circuit 2 that is to be cooled as driving gas, this solution makes it possible to economize on the expansion of this hydrogen stream for a more advantageous use (expansion in a liquid turbine for example).

Certain embodiments of the invention additionally make it possible to reduce the risk of sending impurities to the storage 13, because the boil-off gas recovered will be purified again when it combines with the feedstock of the facility 1.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-12. (canceled)

13. A facility for refrigerating and liquefying hydrogen to a cryogenic temperature, the facility comprising:
a circuit configured to cool hydrogen, the circuit comprising an upstream end configured to be connected to a hydrogen source and a downstream end connected to a member configured to collect a cooled and/or liquefied hydrogen;
a set of heat exchanger(s) in a heat exchange relationship with the circuit for hydrogen that is to be cooled;
a cooling device in a heat exchange relationship with the set of heat exchanger(s), said cooling device comprising a refrigerator performing a refrigeration cycle on a cycle gas in a working circuit, the cycle gas being hydrogen, the working circuit of the refrigerator comprising:
a member for compressing the cycle gas,
a member for cooling the cycle gas,
a member for expanding the cycle gas comprising at least one turbine, and
a member for warming the cycle gas; and
the facility comprising at least an ejector of which the driving-fluid inlet opening is connected, via a set of pipe(s) and valve(s) to the working circuit of the refrigerator downstream of the expansion member, the intake of the ejector being connected to a set of pipe(s) equipped with valve(s) having an end intended to be connected to the gas overhead of at least one mobile tank for transporting liquefied hydrogen, notably a liquefied hydrogen transport tank configured to be filled with liquid hydrogen by the downstream end of the hydrogen circuit, the outlet of the ejector being connected, via a set of pipe(s) and the valve(s), to the working circuit of the refrigerator.

14. The facility as claimed in claim 13, further comprising several ejectors.

15. The facility as claimed in claim 13, further comprising at least one liquefied hydrogen tank transport tank comprising a fluid inlet configured to be connected removably to the downstream end of the hydrogen circuit with a view to being filled with cooled hydrogen, the at least one tank comprising a boil-off gas outlet configured to be connected removably to the suction intake of the ejector via the set of pipe(s) equipped with valve(s).

16. The facility as claimed in claim 13, wherein the cooling device comprises a precooling member in the heat exchange relationship with part of the set of heat exchanger(s).

17. A method for refrigerating hydrogen to a cryogenic temperature, notably for liquefying hydrogen, using a facility in accordance with claim 13, the method comprising a step of drawing boil-off gas from a mobile liquefied hydrogen transport tank into the suction intake of the ejector using, as driving fluid for the ejector, pressurized working gas from the working circuit, the outlet stream from the ejector being injected into the working circuit.

18. The method as claimed in claim 17, wherein the boil-off gas sucked up is at a pressure of between 1.01325 and 1.5 bara, and preferably of between 1.15 and 1.3 bara and at a temperature of between the saturation temperature of the hydrogen and 60 K.

19. The method as claimed in claim 17, wherein the pressure of the driving fluid is between 5 and 10 bara, and preferably of between 6 and 7 bara, the temperature of the driving fluid being between 28 and 35 K and preferably between 29.3 and 30 K.

20. The method as claimed in claim 17, wherein the outlet stream leaving the ejector is at a pressure greater than or equal to the pressure of the cycle gas at the coldest point in the working circuit.

21. The method as claimed in claim 17, wherein the outlet stream leaving the ejector is at a pressure of between 1.25 and 2 bara and preferably between 1.3 and 1.45 bara.

22. The method as claimed in claim 17, wherein the flowrate of driving fluid is controlled as a function of the outlet pressure of the ejector, said flowrate being regulated to maintain a constant pressure set point at the outlet of the ejector.

23. The method as claimed in claim 17, wherein the working circuit of the refrigerator comprises several heat exchangers in series between a hot end of the working circuit in which end the working fluid is at a relatively high pressure, and a relatively cold end of the working circuit in which end the fluid is at a relatively low pressure, the outlet stream from the ejector being injected into the working circuit at the cold end.

24. The method as claimed in claim 17, wherein the method further comprises, simultaneously, drawing boil-off gas from a plurality of mobile liquefied hydrogen transport tanks into the suction intake of a plurality of using, as driving fluid for the ejectors, pressurized working gas from the working circuit, the outlet streams from the ejectors being injected into the working circuit.
